(19) United States
(12) Patent Application Publication
(10) Pub. No.: US 2024/0239154 A1
(43) Pub. Date: Jul. 18, 2024

(54) THERMOELECTRIC CONDITIONING SYSTEM AND METHODS

(71) Applicant: GENTHERM INCORPORATED, Northville, MI (US)

(72) Inventors: Chad Vincent Pacilli, Windsor (CA); Masahiko Inaba, Chino Hills, CA (US); Rodolfo Ernesto Uribe Palafox, Novi, MI (US); Daniel Charles Guerithault, Ann Arbor, MI (US); Kenneth Turner, Novi, MI (US); Amey Pise, Farmington Hills, MI (US); Scott Wolas, Pasadena, CA (US)

(21) Appl. No.: 18/620,713

(22) Filed: Mar. 28, 2024

Related U.S. Application Data
(63) Continuation of application No. 17/309,456, filed on May 27, 2021, now Pat. No. 11,993,132.
(60) Provisional application No. 62/773,961, filed on Nov. 30, 2018.

(51) Int. Cl. B60H 1/22; B60H 1/00

(52) U.S. Cl. CPC B60H 1/2225; B60H 1/00428; B60H 1/00485; B60H 1/00785; B60H 1/00807; B60H 1/00828; B60H 1/00285; B60H 1/00478

(57) ABSTRACT

A system for thermally conditioning and moving a fluid includes a thermoelectric device to convert electrical energy into thermal energy and produce a temperature change in response to an electrical current being applied thereto. The thermoelectric device can include a main-side and a waste side. A fluid moving device can produce a fluid flow that is in thermal communication with the thermoelectric device so that the thermal energy generated by the thermoelectric device is transferred to or from the fluid flow. A flow control valve selectively can direct the fluid flow along a main-side fluid flow path and/or a waste side fluid flow path.

### CROSS-REFERENCE TO RELATED APPLICATIONS

This application is a continuation of U.S. application Ser. No. 17/309,456, filed May 27, 2021, which is a 371 of international PCT Application No. PCT/US2019/063445, filed Nov. 26, 2019, which claims priority to U.S. Provisional Application No. 62/773,961, filed Nov. 30, 2018, which is hereby incorporated herein by reference in its entirety for all purposes and are to be considered a part of this specification.

### BACKGROUND

### Field

This disclosure generally relates to climate control, and, more particularly, to a climate control system.

### Related Art

Temperature modified air for environmental control of living or working space is typically provided to relatively extensive areas, such as entire buildings, selected offices, or suites of rooms within a building. In the case of vehicles, such as automobiles, the entire vehicle is typically cooled or heated as a unit. There are many situations, however, in which more selective or restrictive air temperature modification is desirable. For example, it is often desirable to provide an individualized climate control for an occupant seat so that substantially instantaneous heating or cooling can be achieved. For example, an automotive vehicle exposed to the summer weather, where the vehicle has been parked in an unshaded area for a long period of time, can cause the vehicle seat to be very hot and uncomfortable for the occupant for some time after entering and using the vehicle, even with normal air conditioning. Furthermore, even with normal air-conditioning, on a hot day, the seat occupant's back and other pressure points may remain sweaty while seated. In the winter time, it is highly desirable to have the ability to quickly warm the seat of the occupant to facilitate the occupant's comfort, especially where the normal vehicle heater is unlikely to warm the vehicle's interior as quickly.

For such reasons, there have been various types of individualized climate control systems for vehicle seats and other climate-controlled environments. In such systems, a thermal conditioning system can thermally condition the air and delivers the conditioned air into the environment to cool or heat the space.

### SUMMARY

A system for thermally conditionings and moving a fluid, includes a thermoelectric device to convert electrical energy into thermal energy to produce a temperature change in response to an electrical current being applied thereto. The thermoelectric device has a main-side and a waste side. A fluid moving device produces a fluid flow that is in thermal communication with the thermoelectric device so that the thermal energy generated by the thermoelectric device is transferred to or from the fluid flow. A flow control valve selectively directs the fluid flow along a main-side fluid flow path and/or a waste side fluid flow path.

In another aspect, a control unit operatively connects with a fluid moving device and the flow control valve operates the fluid moving device and the flow control valve.

In another aspect, a sensor provides a signal that is indicative of a temperature of the fluid flow.

In another aspect, the control unit operates the flow control valve based on the signal.

In another aspect, the control unit adjusts the flow control valve and approximately equal proportions of the fluid flow are directed to the waste side fluid flow path and the main-side fluid flow path.

In another aspect, the control unit adjusts a flow control valve position based on a desired main-side temperature.

In another aspect, the control unit lowers the main-side temperature and/or increases a temperature differential between the main-side and the waste side by adjusts the flow control valve to direct more of the fluid flow to the waste side fluid flow path than to the main-side fluid flow path.

In another aspect, the flow control valve is adjusted from a fully open position towards a fully closed position.

In another aspect, the control unit adjusts the flow control valve wherein less than 20% of a total volume of the fluid flow on the main-side and waste-side paths is directed to the main-side fluid flow path to achieve a high temperature differential between the main-side and the waste side of the thermoelectric device.

In another aspect, the control unit adjusts a proportion of the fluid flow directed to the main-side fluid flow path to prevent condensation in the fluid flow.

In another aspect, the control unit adjusts the fluid flow provided by the fluid moving device based on a position of the flow control valve.

In another aspect, the control unit increases the fluid flow when the fluid flow is proportioned towards the main-side fluid flow path.

In another aspect, the control unit maintains the fluid flow by lowering a speed of the fluid moving device when the position of the flow control valve is increases backpressure on the fluid moving device, such as by lowering a voltage applied to the fluid moving device.

In another aspect, the control unit adjusts a proportion of the fluid flow directed to the main-side fluid flow path based on cabin environment wettedness.

In another aspect, the control unit adjusts a conditioned air temperature by adjusts a proportion of the fluid flow along the main-side fluid flow path and a bypass flow path and blends cooler air from the main-side fluid flow path with warmer air from the bypass flow path to create the conditioned air at an intermediate temperature.

In another aspect, the control unit directs more of the fluid flow to the main-side fluid flow path than the waste side fluid flow path to prevent condensation in the fluid flow and to increase cools capacity of the system at a limited temperature differential between the main-side and the waste side of the thermoelectric device.

In another aspect, the control unit directs a first proportion of the fluid flow to the main-side fluid flow path for a first time period and a second proportion of the fluid flow to the main-side fluid flow path for a second time period, the first time period set to form an acceptable amount of condensation in fluid flow.

In another aspect, the first and/or second time periods are set to maintain a pre-set temperature differential between the main-side and the waste side of the thermoelectric device.

In another aspect, the control unit directs substantially all of the fluid flow along the main-side fluid flow path to provide a high ventilation rate.

In another aspect, the control unit operates the thermoelectric device as a heater and direct substantially all or most of the fluid flow along the main-side fluid flow path to increase heats capacity and avoid losses associated with heat removal and air flow on the waste side of the thermoelectric device.

In another aspect, the control unit adjusts the flow control valve position based on a cabin air temperature and humidity.

A control method claim for a thermal conditioning system includes powering a TED of the thermal conditioning system has a main side and a waste side, the thermal conditioning system operates in a first mode for a first period in which a fluid flow passes through the thermal conditioning system. A first portion of the fluid flow is directed through the waste side at a first flow rate and a second portion of the fluid flow is directed through the main side at a second flow rate. The thermal conditioning system operates in a second mode for a second period in which a ratio between the first flow rate and the second flow rate is changed as compared to the first mode.

In another aspect, the first mode is an initial mode.

In another aspect, a target temperature of the fluid flow is detected using a temperature sensor and operation changes from the first mode to the second mode based on detecting the target temperature.

In another aspect, the target temperature is detected on the main side.

In another aspect, a temperature differential between the main side and the waste side is measured and operation changes from the first mode to the second mode based on detecting the measured temperature differential.

In another aspect, condensation on the main side is detected that changes operation from the first mode to the second mode based on detecting the condensation.

In another aspect, in the second mode, the ratio between the first flow rate through the waste side and the second flow rate through the main side is decreased relative to the first mode.

In another aspect, in the second mode the first flow rate through the waste side and the second flow rate through the main side are approximately equal.

In another aspect, in the second mode the first flow rate that passes through the waste side is less than the second flow rate through the main side.

In another aspect, the thermal conditioning system operates in a third mode for a third period in which at least one of a total fluid flow through the thermal conditioning system and the power to the TED is decreased relative to the second mode.

In another aspect, the fluid flow between the main side and the waste side is directed with a valve.

A thermal conditioning system, includes a TED with a main side and a waste side, a main-side path along the main side of the TED and a waste-side path along the waste side of the TED. A controller operates the thermal conditioning system in a first mode for a first period in which a first fluid flow passes along the waste-side path at a first flow rate and a second fluid flow passes along the main-side path at a second flow rate and in a second mode for a second period in which a ratio between the first flow rate and the second flow rate is changed.

In another aspect, a valve directs the first and second fluid flows between the main-side path and the waste-side path. The controller operates the valve to change between the first and second modes.

In another aspect, wherein the first mode is an initial mode.

In another aspect, a temperature sensor detects a temperature of the second fluid flow. The controller further receives a signal from the temperature sensor and change operation from the first mode to the second mode based on the signal.

In another aspect, a temperature sensor detects a differential temperature between the first and second fluid flows. The controller receives a signal from the temperature sensor and changes operation from the first mode to the second mode based on the signal.

In another aspect, a humidity sensor detects a humidity of the second fluid flow. The controller receives a signal from the humidity sensor and changes operation from the first mode to the second mode based on the signal.

In another aspect, the first and second flow rates are approximately equal in the second mode.

In another aspect, the second flow rate is greater than the first flow rate in the second mode.

In another aspect, the controller operates the thermal conditioning system in a third mode for a third period in which at least one of the fluid flow through the thermal conditioning and the power to the TED is decreased relative to the second mode.

### BRIEF DESCRIPTION OF THE DRAWINGS

Various examples are depicted in the accompanying drawings for illustrative purposes, and should in no way be interpreted as limiting the scope of the examples. Various features of different disclosed examples can be combined to form additional examples, which are part of this disclosure.

FIG. 1 shows a thermal conditioning system including a flow control valve for directing a fluid flow along a main-side path and a waste side path;

FIG. 1A shows fluid flow through the thermal conditioning system with the flow control valve in a neutral position;

FIG. 1B shows fluid flow through the thermal conditioning system with the flow control valve in a waste-side blocking position;

FIG. 1C shows fluid flow through the thermal conditioning system with the flow control valve in a main-side blocking position;

FIG. 2 shows another implementation of a thermal conditioning system including a flow control valve for directing a fluid flow along a main-side path, a waste side path, and a bypass path;

FIG. 2A shows fluid flow through the thermal conditioning system with the flow control valve blocking the bypass path and partially blocking the main-side path;

FIG. 2B shows fluid flow through the thermal conditioning system with the flow control valve blocking the bypass path;

FIG. 2C shows fluid flow through the thermal conditioning system with the flow control valve blocking the waste side path;

FIG. 3A shows a schematic thermal conditioning system including a flow control valve in a fully closed position blocking a main-side path;

FIG. 3B shows the flow control valve in a neutral position between the main-side path and a waste-side path;

FIG. 3C is a graph showing airflow through the main-side path against the position of the flow control valve;

FIG. 3D is a graph showing a maximum temperature differential (Delta T) across the main and waste sides of the thermoelectric device of the thermal conditioning system against the position of the flow control valve;

FIG. 4 shows a schematic thermal conditioning system including a flow control valve in a neutral position between a main-side flow path and a waste-side flow path;

FIG. 5 shows the schematic thermal conditioning system with the flow control valve partially blocking the main-side flow path;

FIG. 6 shows the schematic thermal conditioning system with the flow control valve fully blocking the main-side flow path;

FIG. 7 shows the schematic thermal conditioning system with the flow control valve partially blocking the waste-side flow path;

FIG. 8 shows the schematic thermal conditioning system with the flow control valve fully blocking the waste-side flow path;

FIG. 9 is a graph showing a maximum temperature differential (Delta T) across the main and waste sides of the thermoelectric device of the thermal conditioning system and volumetric flow rates across the main and waste sides against the position of the flow control valve;

FIG. 10 shows a flow chart for operating a thermal conditioning module;

FIG. 11 shows another implementation of a thermal conditioning module.

### DETAILED DESCRIPTION

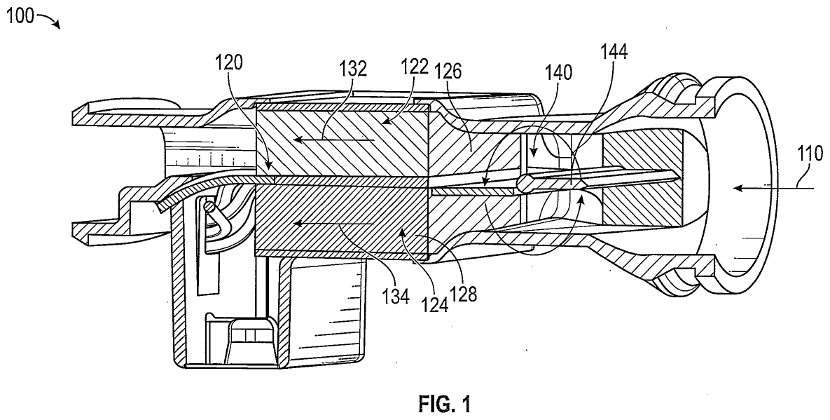

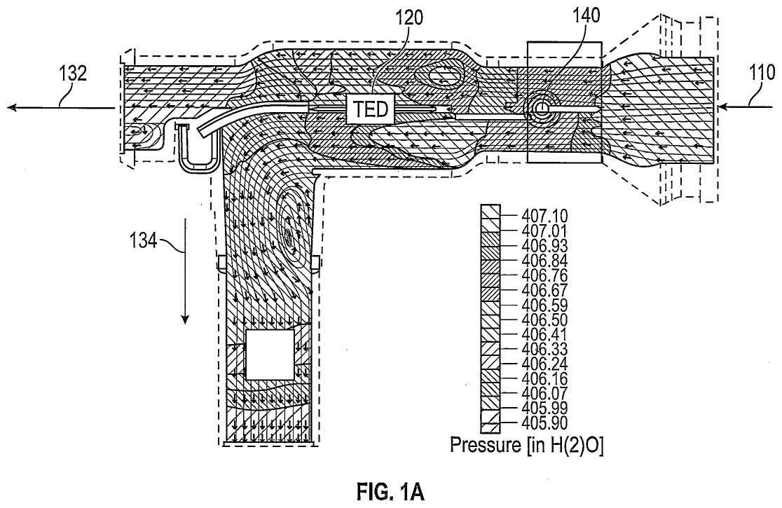

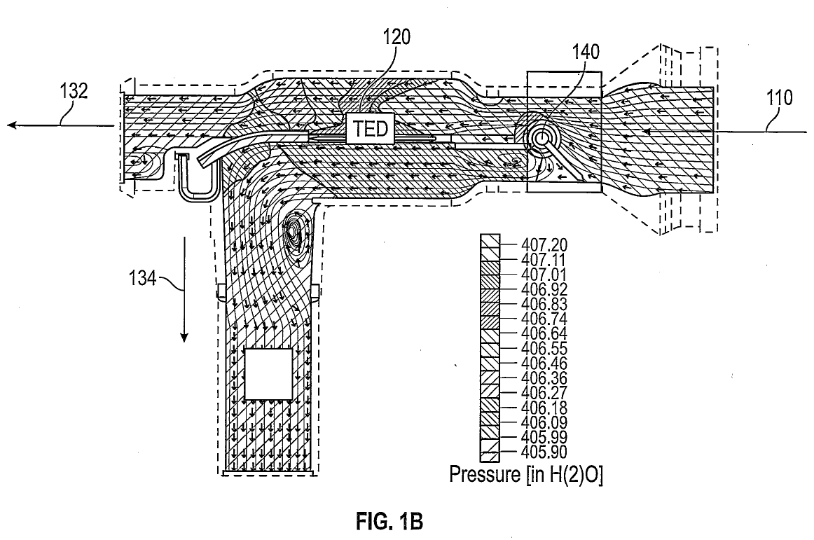

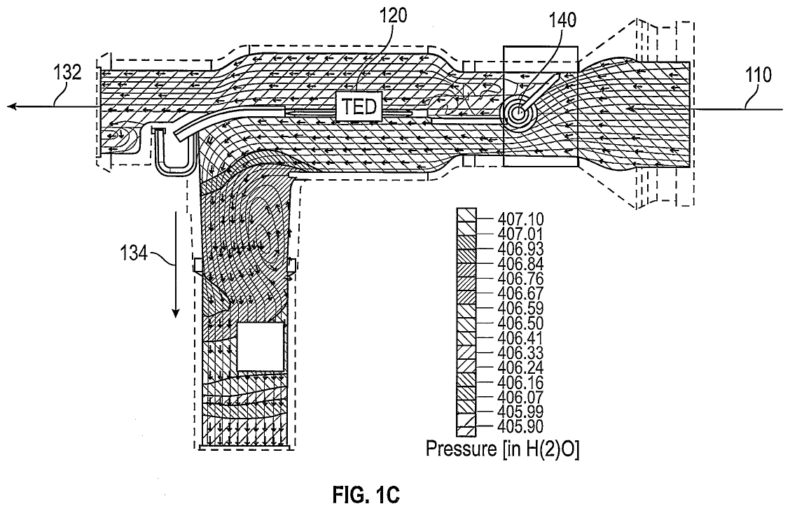

FIG. 1 shows an implementation of a thermal conditioning system 100. The thermal conditioning system 100 can be used to deliver conditioned (e.g., heated, cooled, dried, and/or wetted) air to a climate-controlled device or environment. In an exemplary implementation, the thermal conditioning system 100 can deliver conditioned air into a vehicle seat, such as through one or more passages or channels within the vehicle seat. The thermal conditioning system 100 can also be used to provide conditioned air to various other spaces or components such as an enclosed space, a bed, space, and/or sofa.

The thermal conditioning system 100 can include or be used in combination with a fluid moving device (not shown). The fluid moving device can be a fan, blower, or similar device. The fluid moving device can include a motor for driving one or more blades. A speed of the fluid moving device can controlled based on application of a voltage and/or amperage to the motor. The fluid moving device can deliver a fluid flow through the thermal conditioning system 100. The fluid flow, or a portion thereof, can be conditioned by passing through the thermal conditioning system 100. The fluid flow can be delivered through the thermal conditioning system 100 along a flow path 110. This in the illustrated implementation the fluid moving device can be positioned, in general, upstream of the conditioning elements of the thermal conditioning system 100. However, in other implementations, a fluid moving device can be positioned downstream of the conditioning elements in addition to or in the alternative to an upstream fluid moving device.

The thermal conditioning system 100 can include a thermoelectric device (TED) 120. The TED 120 can be a Peltier device. The TED 120 can include a main-side 122 and a waste side 124. The TED 120 can be controlled based on application of a voltage and/or amperage. When used as a cooling device, the main-side 122 can be colder than the waste side 124. When used as a heating device, the main-side 122 can be hotter than the waste side 124.

The TED 120 can include a main-side heat exchanger 126 and/or a waste-side heat exchanger 128. In certain implementations, the heat exchangers can comprise a plurality of thin metal fins. The flow path 110 can split into a main-side flow path 132 and a waste-side flow path 134. The main-side flow path 132 can pass through the main heat exchanger 126. The waste-side flow path 134 can pass through the waste heat exchanger 128. The main-side flow path 132 can terminate at the climate-controlled environment or device. The waste-side flow path 134 can terminate at an exhaust.

The thermal conditioning system 100 can include a flow control valve 140. The flow control valve 140 can be upstream of the TED 120. However, it is anticipated that in other implementations the flow control valve can be positioned downstream of the TED 120 and/or that additional valves can be provided. For example, individual valves could be provided each of the flow paths 132, 134 for the main and waste sides of the thermal conditioning system. The flow control valve 140 can include a louver or flap 144. The position of the louver can proportion the fluid flow provided by the fluid moving device between the main and waste-side flow paths 132, 134. Optionally, the louver can proportion the fluid flow to a bypass flow path (not shown). The position of the louver can be controlled by a motor (e.g., a servo, step, or other motor type) or actuator. In the illustrated implementation, the flow control valve 140 is in the form of a flap valve, however other types of valves could be used such as needle, barrel or rotary valves and/or a combination of such valves.

FIG. 1A shows pressure of the fluid flow through the thermal conditioning system 100 with the flow control valve 140 in a neutral position. FIG. 1B shows pressure of the fluid flow through the thermal conditioning system 100 with the flow control valve 140 in a position blocking the waste-side flow path 134. FIG. 1C shows pressure of the fluid flow through the thermal conditioning system 100 with the flow control valve 140 in a position blocking the main-side flow path 132.

Conventional climate-controlled systems can use a fluid moving device and TED for climate control. These systems can operate by varying the total air flow provided by the fluid moving device and the power provided to the TED to achieve the desired conditioned air temperatures and thermal conditioning capacities. The addition of the flow control valve 140 provides the thermal conditioning system 100 with additional control over the conditioning of the fluid flow compared with conventional systems. For example, the thermal conditioning system 100 can provide a greater change in air temperature, provide additional control of conditioned air temperature for any given fluid moving device and TED operating condition, and/or provide additional climate control operating modes or options as will be described in more detail below. Accordingly, the thermal conditioning system 100 can advantageously decrease time to sensation and/or increase efficiency of the TED 120 and/or fluid moving device.

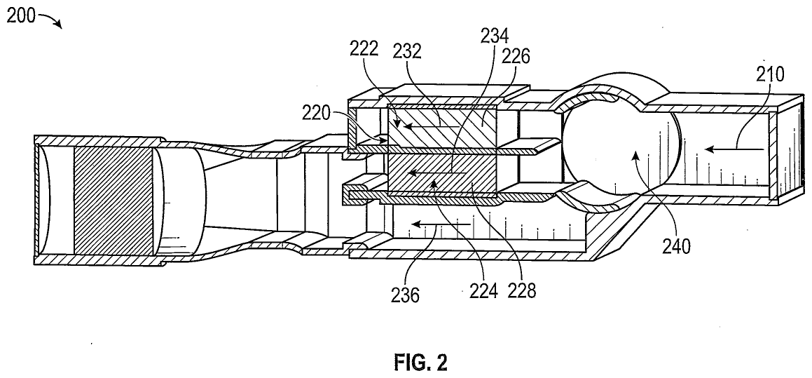

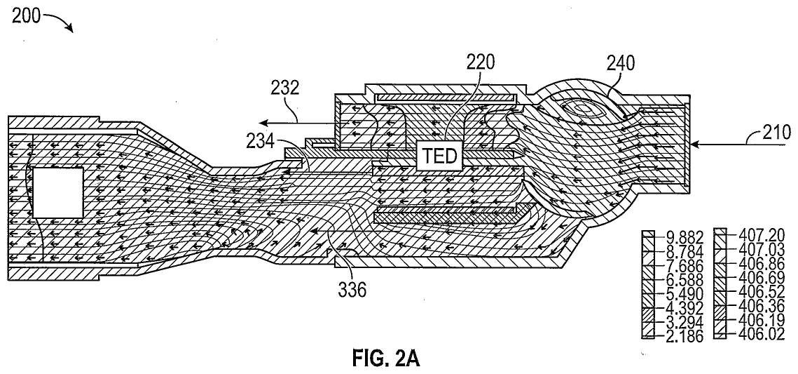

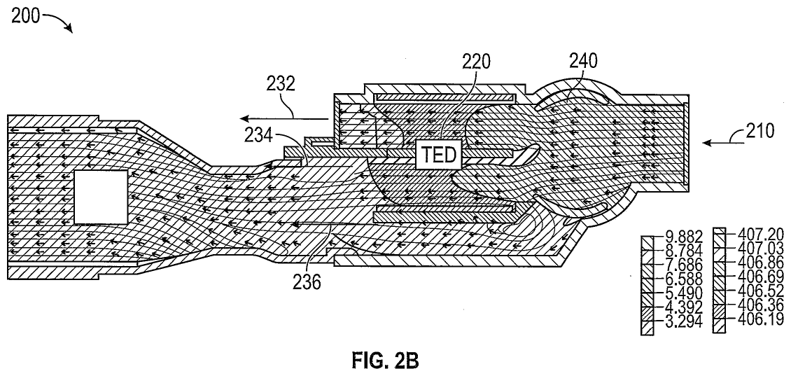

FIG. 2 shows another implementation of thermal conditioning system 200. The thermal conditioning system 200 can operate similarly to and/or include components similar to the thermal conditioning system 100. The thermal conditioning system can include a TED 220. The TED 220 can include a main-side 222 and a waste side 224. The TED 220 can include a main-side heat exchanger 226 and/or a waste-side heat exchanger 228.

The thermal conditioning system 200 can include a fluid flow path 210 for a fluid flow from a fluid moving device (not shown). The fluid flow path 210 can pass through a flow control valve 240. The flow control valve 240 in the illustrated implementation can be a rotary valve. The flow control valve 240 can direct the fluid flow through a main-side flow path 232, a waste-side flow path 234, and/or a bypass path 236.

FIG. 2A shows pressure of the fluid flow through the thermal conditioning system 200 with the flow control valve 240 in a position blocking the bypass path 236 and partially blocking the main-side flow path 232. FIG. 2B shows pressure of the fluid flow through the thermal conditioning system 200 with the flow control valve 240 in a position blocking the bypass path 236 only. FIG. 2C shows pressure of the fluid flow through the thermal conditioning system 200 with the flow control valve 240 in a position blocking the waste-side flow path 234.

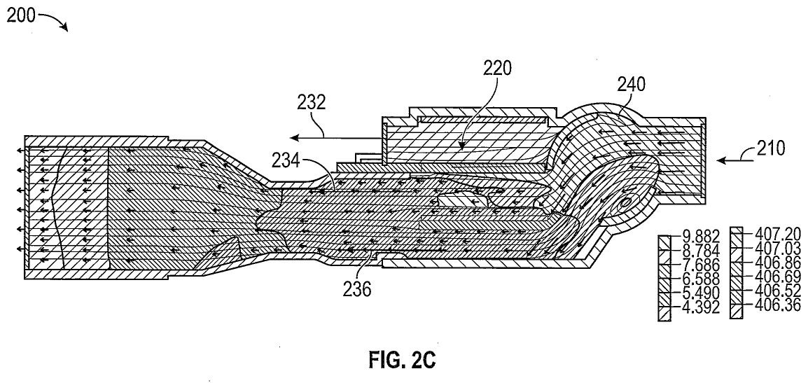

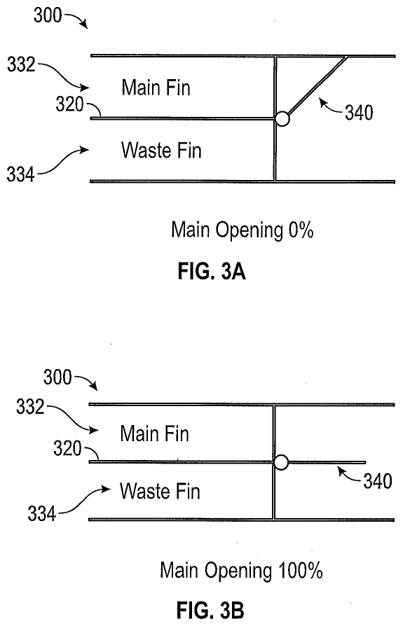

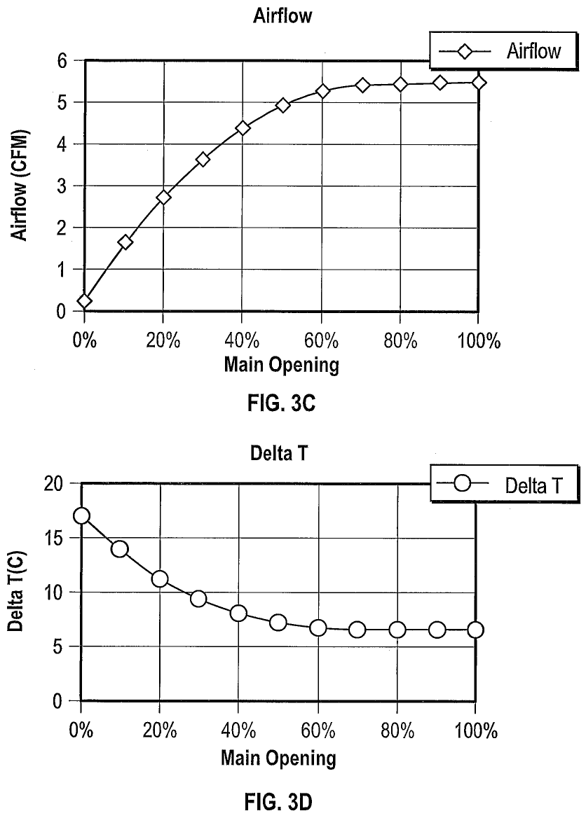

FIG. 3A illustrates a thermal conditioning system 300 including a flow control valve 340, a TED 320, a main-side flow path 332 and a waste-side flow path 334. The flow control valve 340 in a fully closed position (0%) can block the main-side of the TED 320. FIG. 3B illustrates the flow control valve 340 in a fully open position (100%) allowing fluid flow over both main and waste sides of the TED 320. FIG. 3C is a graph showing airflow through a main-side flow path 332 for different open positions of the flow control valve 340. FIG. 3D is a graph showing a maximum temperature differential (Delta T) across the main and waste sides of the TED 320 for different open positions of the flow control valve 340.

As noted above, conventional climate-controlled systems divided in a fixed manner allow air flow over the main side and the waste side of a TED. In certain implementations, conventional climate-controlled systems with a fixed divided air flow between the main side and the waste side of the TED 320 can achieve a maximum temperature differential (Delta T) of around 7 degrees (C.), as shown in FIG. 3D at the fully open (100%) position of the main-side flow path 332. Closing or limiting fluid flow along the main-side flow path 332 improves the Delta T (e.g., by reducing the total volume or air being heated or cooled on the main side). In certain implementations, the flow control valve 340 enables Delta Ts as high as around 17 degrees (C.). Improvement of the Delta T can achieve lower temperatures for the conditioned air form the main-side flow path 332 that is delivered to the climate-controlled environment. In certain contexts, such as in an air-conditioned seating unit, the lower temperatures can be desirable as to produce an increased cooling sensation for a seat occupant. The configurations and operation illustrated and described with respect to FIGS. 3A and 3B can be used with the implementations of the thermal conditioning systems described above with respect to FIGS. 1 and 2.

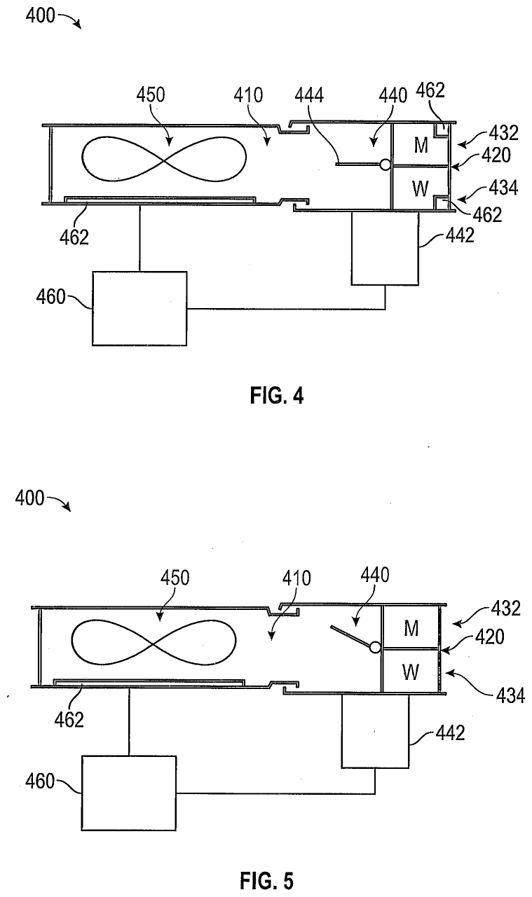

FIG. 4 schematically illustrates a thermal conditioning system 400, similar to the thermal conditioning system 100. The thermal conditioning system 400 can include a fluid moving device 450 for moving a fluid flow along a fluid flow path 410. The fluid flow path 410 can proceed along a main-side flow path 432 and/or a waste-side flow path 434. The thermal conditioning system 400 can include a TED 420. The TED 420 can have a main side 422 and a waste side 424. The TED 420 can include one or more air heat exchangers (not shown). A flow control valve 440 can direct and/or proportion air along the main and/or waste-side flow paths 432, 434. The flow control valve 440 can include a motor 442 and/or a louver or rotor 444.

The thermal conditioning system 400 can include a controller 460. The controller 460 can be singular or spread across several control devices. The controller 460 can be operatively coupled with the motor 442 for controlling the flow control valve 440. The controller 460 can be operatively coupled with the TED 420 and/or the fluid moving device 450. The controller 460 can include a processor for executing programming instructions on a computer readable medium configured to operate the thermal conditioning system 400 according to one or more operation modes.

The thermal conditioning system 400 can include one or more sensors 462. The sensors 462 can include temperature and/or humidity sensors and configured to measure the fluid flow. The sensors 462 can be mounted in the fluid flow path 410, in the fluid moving device 450, in the main and/or waste-side flow paths 432, 434, and/or elsewhere within the thermal conditioning system 400 and in certain implementation the sensors 462 can be positioned upstream, downstream and/or within the main or waste-side heat exchangers. The sensors 462 can be communicatively coupled with the controller 460. The controller 460 can operate the thermal conditioning system 400 based, at least in part, on a signal from the sensors 462.

FIGS. 4-8 show illustrate the thermal conditioning system 400 with the flow control valve 440 in open, closed, and intermediate (partially open) positions according to various operation modes, as described below.

In certain implementations, the controller 460 can operate the thermal conditioning system 400 in a Conventional Mode which is schematically illustrated in FIG. 4. In the Conventional Mode, the fluid flow from the fluid moving device 450 passes over the main and waste sides 422, 424 (e.g., the volumetric fluid flow rates between the main and waste-side flow paths 432, 434) in an approximately equal and/or at a static predetermined ratio. The controller 460 (by operation of the flow control valve 440) modifies the conditioned air temperature by adjusting one or both of the power (e.g., voltage and/or amperage) provided to the TED 420 and the total fluid flow from the air moving device 450 (e.g., by speeding up or slowing).

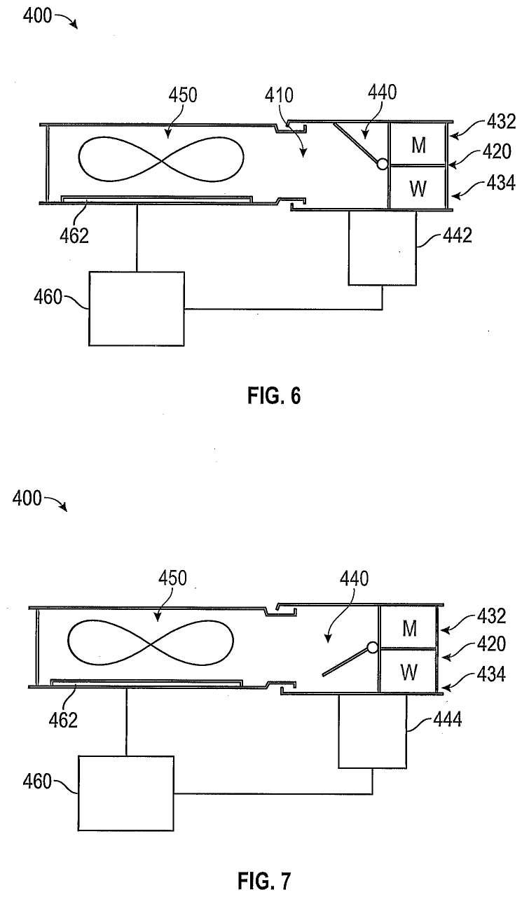

The controller 460 can operate the thermal conditioning system 400 in a High Delta T Mode, which is schematically illustrated in FIGS. 5 and 6. In the High Delta T Mode, the flow control valve 440 can partially or fully close the main-side flow path 432. The controller 460 can operate in the High Delta T Mode in a high temperature and/or low humidity cabin air operating environment (e.g., ambient temperature 32-45 degrees (C.), relative humidity less than 20%). In the High Delta T Mode, the cabin air passing through the thermal conditioning system 400 can be cooled to lower temperatures than the Conventional Mode. The controller 460 (by operation of the flow control valve 440) can proportion more fluid flow to the waste-side flow path 434 to achieve a high Delta T and a low conditioned air temperature on the main-side flow path 432 (e.g., relative to the conditioned air temperature on the main-side flow path 432 with fluid flow along the main and waste-side flow paths 432, 434 being equal). In the High Delta T Mode, the conditioned air temperature can be prioritized over conditioned air flow. The High Delta T Mode, can include a conditioned air target temperature. In the High Delta T Mode, the conditioned air temperature target can be 25 degrees (C.). This can be to reduce time to sensation by occupant and/or provide optimal conditioned air temperature for comfort.

FIG. 9 illustrate a chart showing the dT (temperature differential between the main and waste-side flow paths 432, 434) and total flow rates and ratios of flow rates between the main and waste-side flow paths 432, 434 against the position of the flow control valve 440 (in 10° increments P0-P10). In certain implementations, the High Delta T Mode can be represented in the chart of FIG. 9 between P0 and any of P1-P2. In certain implementations of the High Delta T Mode, the flow control valve 440 can be open approximately between 0% and 20%, 0% and 10%, or 0% and 5%. In certain implementations of the High Delta T Mode, a ratio of the fluid flow along the main and waste-side flow paths 432, 434 can be approximately between 0 and 0.3, 0.1 and 0.3, 0.1 and 0.2. In certain implementations of the High Delta T Mode, the fluid flow volume through the main side can be approximately between 0 and 3 CFM (cubic feet/minute), 0 and 2 CFM, and 0 and 1 CFM. In certain implementations of the High Delta T Mode, the dT (temperature differential between the main and waste-side flow paths 432, 434) can be approximately between 25° C. and 12° C. or 25° C. and 20° C.

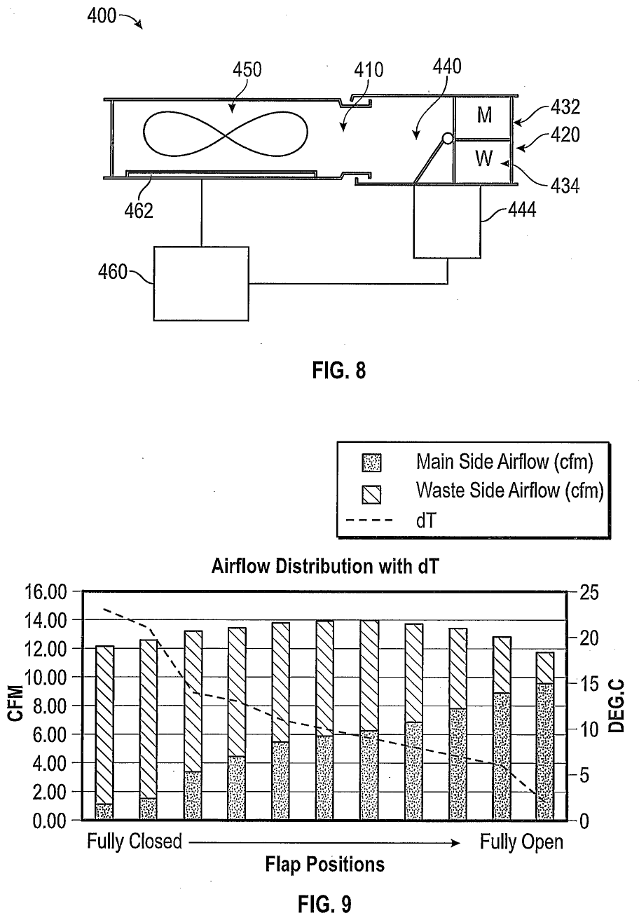

The controller 460 can operate the thermal conditioning system 400 in a High Air Flow Mode which is schematically illustrated in FIGS. 7 and 8. In the High Air Flow Mode, the flow control valve 440 can partially or fully close the waste-side flow path 434. The controller 460 can operate in the High Air Flow Mode in cabin air environments where humidity limits achieving the desired (high) Delta T without condensation (e.g., ambient temperature 25-32 degrees (C.), relative humidity less than 60%). The controller 460 can proportion more or all of the fluid flow to the main-side flow path 432 compared with the waste-side flow path 434 to increase cooling capacity for the thermal system 400 operating at the limited Delta T (which may be at a higher conditioned air temperature). In the High Air Flow Mode, the cooling capacity of the thermal system 400 can be increased without generating condensation. Further, the controller 460 can control power to the TED 420 to achieve the desired conditioned air temperatures and/or humidities.

In certain implementations, the High Air Flow Mode can be represented in the chart of FIG. 9 between P1 or P2 and P10. In certain implementations of the High Air Flow Mode, the flow control valve 440 can be open approximately between 20% and 100%, 10% and 100%, or 5% and 100%. In certain implementations of the High Air Flow Mode, the flow control valve 440 can be open greater than approximately 5%, 10%, or 20%. In certain implementations of the High Air Flow Mode, a ratio of the fluid flow along the main and waste-side flow paths 432, 434 can be approximately 1.0 or between 0.5 and 5.0 or greater. In certain implementations of the High Air Flow Mode, the fluid flow volume through the main side can be approximately between 4 and 10 CFM, or greater than approximately 2, 3, or 4 CFM. In certain implementations of the High Air Flow Mode, the dT (temperature differential between the main and waste-side flow paths 432, 434) can be approximately between 13° C. and 1° C. or less than approximately 13° C.

The controller 460 can operate the thermal conditioning system 400 in a Sequential High Delta T, High Air Flow Mode. The controller 460 can operate in the Sequential High Delta T, High Air Flow Mode in cabin air environments with humidity limiting cabin environments (e.g., ambient temperature greater than 25 degrees (C.) and relative humidity causing condensation within the thermal conditioning system 400). The controller 460 can operate for a first period in the High Delta T Mode, during which an acceptable amount of condensation can form. The controller 460 can then switch to operation in the High Air Flow Mode to remove the condensation for a second period. The periods of operation may be set to maintain a desired range in Delta T. The Delta T range can be set, for example, to avoid occupant perception of the conditioned air temperature range and/or to maintain occupant comfort. Further, the controller 460 can control power to the TED 420 to achieve the desired conditioned air temperatures and/or humidities. In another operative example, the controller 460 can operate the High Delta T Mode past the condensation point and then in the High Air Flow Mode to dry the thermal conditioning system 400. This process can be noisy and could be used as a preconditioned mode (no occupant in the climate-controlled environment).

The controller 460 can operate the thermal conditioning system 400 in a Ventilation Mode which is schematically illustrated in FIGS. 7 and 8. The controller 460 can operate in the Ventilation Mode in cabin air environments where the cabin air temperature is sufficient to achieve occupant comfort. The controller 460 will proportion substantially all fluid flow over the main-side flow path 432 with the TED 420 powered off and/or through a bypass flow path. In the Ventilation Mode, the thermal conditioning system 400 can provide high ventilation rates for both rotary and louver type flow control valves. The controller 460 can operate in the Ventilation Mode for a first period and operate in one or more of the Conventional Mode, the High Delta T Mode, the High Air Flow Mode, and/or the sequential High Delta T, High Air Flow Mode for a second period.

The controller 460 can operate the thermal conditioning system 400 in a Modified Heating Mode. The controller 460 can operate in the Modified Heat Mode in cabin air environments where the cabin air temperature is low and heating is desired for occupant comfort. The TED 420 can be operated with a reverse polarity relative to the above-mentioned cooling modes. The controller 460 can operate the flow control valve 440 to proportion all or a majority of the fluid flow over the main side 422 (acting as a heater) to increase heating capacity and avoid losses associated with heat removal and air flow on waste side 424. To decrease a time to sensation for the heated air, the TED 420 can be operated similar to the High Delta T mode with the flow control valve 440 partially or fully closes on the main-side path 432. This can increase the temperature of the cabin air flowing through the thermal conditioning system 400 relative to operation in the Modified Heating Mode.

In another mode, the thermal conditioning system 400 can operate in cool and/or damp air cabin environments. The controller 460 can increase fluid flow (e.g., by operation of the fluid moving device 450) through the thermal conditioning system 400 to reduce occupant wettedness and/or increase drying of the occupant, which is schematically illustrated in FIGS. 7 and 8. The controller 460 can adjust the flow control valve 440 and/or power to the TED 420 to increase the conditioned air temperature to counteract the evaporative cooling of the occupant associated with the drying.

The controller 460 can adjust the fluid moving device speed based on the position of the flow control valve 440. To maintain a desired fluid flow where the position of the flow control valve 440 is increasing the backpressure, the fluid moving device speed may need to be decreased because at higher backpressures, turbulence within the fluid flow path 410 may cause fluid moving device speed to increase without a corresponding increase in air flow.

In the High Delta T Mode, the thermal conditioning system 400 can avoid generating condensation on the main side 422 by providing sufficient fluid flow across the main side of the TED 420. The sensors 462 can be located on both the main-side flow path 432 and the waste-side flow path 434. The sensors 462 can be used for detecting or measuring a temperature differential between the fluid flow on the main-side flow path 432 and the waste-side flow path 434. Alternatively, the sensors 462 can be upstream of the TED 420 and downstream of the TED 420 on the main-side flow path 432. The controller 460 can receive a signal from the sensors 462 indicating the temperature differential. The controller 460 can compare the temperature differential from the signal with an expected temperature differential between the main and waste sides of the TED 420 for a given position of the flow control valve 440. If the measured temperature differential is less than the expected temperature differential (e.g., within a margin of error), this can mean there is condensation in the main-side flow path. Accordingly, the controller 460 can change operation of the control valve 440 and/or the fluid moving device 450 to increase fluid flow across the main-side flow path to reduce the condensation/humidity. In another implementation, the thermal conditioning system 400 can include a humidity sensor on the main-side flow path to detect humidity or condensation. Based on a signal from the humidity sensor, the controller 460 can alter operation of the operation of the control valve 440 and/or the fluid moving device 450 to increase fluid flow across the main-side flow path to reduce the condensation/humidity.

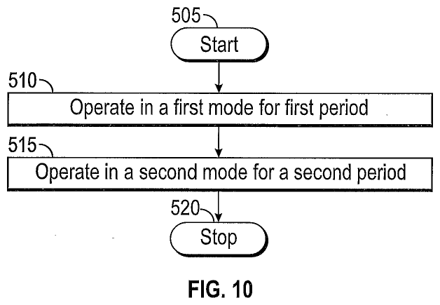

FIG. 10 outlines a control method claim for a thermal conditioning system, such as the systems 100, 200, 300, 400 describe above. At step 505, the method can be initiated. Initiation can be based on providing power to vehicle or other system of which the thermal conditioning system is a component or to the thermal conditioning system itself. At step 510, the thermal conditioning system can operate in a first mode for a first period. The first mode can be any of the operation modes described above. In one particular implementation, the first mode is the High Delta T mode. In the first mode, a fluid flow passes through the thermal conditioning system primarily along a waste-side path. The first mode can include providing power to a TED having a main side and a waste side. The first mode can be an initial mode. In one particular implementation, the High Delta T mode is the initial mode.

At step 515, the thermal conditioning system can operate in a second mode for a second period in which the fluid flow that passes through the thermal conditioning system is changed relative to the fluid flow during the first mode. The fluid flow during the second mode can be directed in a different ratio between the main-side path and the waste-side path than during the first mode. In the second mode, the fluid flow along the main-side path can be increased relative to the fluid flow along the main-side path in the first mode. This can increase the temperature of the fluid flow along the main-side path (e.g., reduce the temperature differential between the main and waste sides of the TED 420) and/or reduce condensation or humidity therein. In the second mode, the fluid flow along the main-side path can be increased to match the fluid flow along the waste-side path. In the second mode, the fluid flow can be primarily along the main-side path. In certain implementations, the second mode can be the High Air Flow mode or the Ventilation Mode.

Transitioning between the main-side path and the waste-side path can be accomplished using a valve to change the direction of the fluid flow between the main-side flow path and the waste-side flow path. Transitioning operation from the first mode to the second mode can be based on any of several variables. The first period can be based on a pre-selected time after which the transition automatically occurs. The transition can be based on detecting a target temperature of the fluid flow using a temperature sensor (e.g., on the main-side path) and/or holding that temperature for a specified time period. The transition can be based on based on detecting condensation. The transition can be based on measuring a temperature differential between the fluid flow on the main-side path and the waste-side path. Too low a temperature differential can indicate condensation or humidity in the main-side path. The transition can be based on maintaining a pre-set temperature differential between the main-side path and the waste-side path. The first and second time periods can be set to maintain a pre-set temperature differential between the main-side and the waste side of the thermoelectric device.

The control method can optionally include operating the thermal conditioning system in a third mode for a third period in which the fluid flow through the thermal conditioning system can be decreased relative to the second mode. In the third mode, power to the TED can be decreased relative to the second mode. The third mode can be used to reduce power consumption by the thermal conditioning system. For example, the third mode can be operable once an comfortable cabin temperature is achieved through operation of the first and second modes.

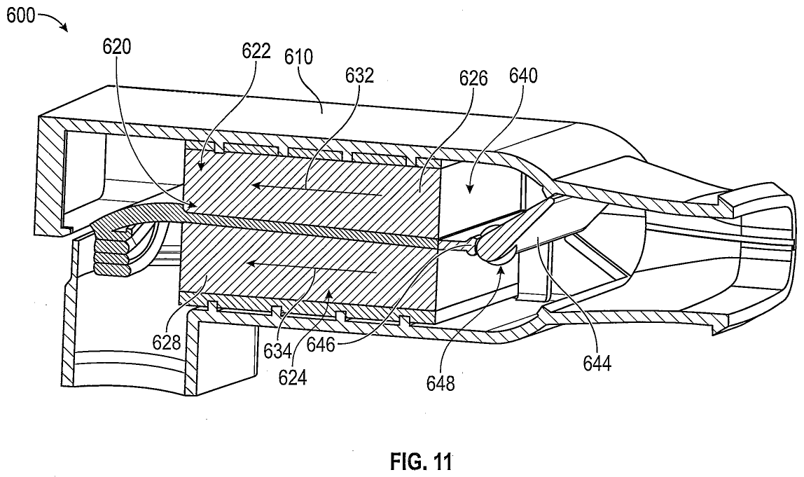

FIG. 11 shows another implementation of a thermal conditioning system 600 including a housing 610. The system 600 can include a TED 620. The TED 620 can be a single unit or comprised of two or more separate TED units. The housing 610 of the system 600 can include a main-side flow path 632 and a waste-side flow path 634. The system 600 can include a flap valve 640. The flap valve 640 can include a louver 644. The louver 644 can be located between the main-side flow path 632 and the waste-side flow path 634. The louver 644 can be movable by a motor, such as a stepper motor. The louver 644 can be rotatable about an axis by the motor. The louver 644 can be mounted on a center wall 646 of the housing 610. The center wall 646 can include one or more mounts 648 for securing the shaft 647. This arrangement can improve air flow over the louver 644.

To assist in the description of the disclosed implementations, words such as upward, upper, downward, lower, vertical, horizontal, upstream, and downstream have been used above to describe the accompanying figures. It will be appreciated, however, that the illustrated implementations can be located and oriented in a variety of desired positions.

It should be noted that the terms “couple,” “coupling,” “coupled” or other variations of the word couple as used herein may indicate either an indirect connection or a direct connection. For example, if a first component is “coupled” to a second component, the first component may be either indirectly connected to the second component via another component or directly connected to the second component.

The functions of a controller described herein may be stored as one or more instructions on a processor-readable or computer-readable medium. The term “computer-readable medium” refers to any available medium that can be accessed by a computer or processor. By way of example, and not limitation, such a medium may comprise random access memory (RAM), read-only memory (ROM), electrically erasable programmable read-only memory (EEPROM), flash memory, compact disc read-only memory (CD-ROM) or other optical disk storage, magnetic disk storage or other magnetic storage devices, or any other medium that can be used to store desired program code in the form of instructions or data structures and that can be accessed by a computer. It should be noted that a computer-readable medium may be tangible and non-transitory. As used herein, the term “code” may refer to software, instructions, code or data that is/are executable by a computing device or processor.

Although several implementations and examples are disclosed herein, the present application extends beyond the specifically disclosed implementations to other alternative implementations and/or uses of the inventions and modifications and equivalents thereof. It is also contemplated that various combinations or subcombinations of the specific features and aspects of the implementations may be made and still fall within the scope of the inventions. Accordingly, it should be understood that various features and aspects of the disclosed implementations can be combine with or substituted for one another in order to form varying modes of the disclosed inventions. Thus, it is intended that the scope of the present inventions herein disclosed should not be limited by the particular disclosed implementations described above, but should be determined only by a fair reading of the claims that follow.

Although the foregoing description of the preferred implementations has shown, described, and pointed out certain novel features, it will be understood that various omissions, substitutions, and changes in the form of the detail of the apparatus as illustrated, as well as the uses thereof, may be made by those skilled in the art without departing from the spirit of this disclosure. Consequently, the scope of the present inventions should not be limited by the foregoing discussion, which is intended to illustrate rather than limit the scope of the inventions.

What is claimed is:

1. A system for thermally conditioning and moving a fluid, comprising:
a housing comprising:
an inlet of a fluid flow path;
a central wall configured to divide the fluid flow path into a main-side fluid flow path and a waste-side fluid flow path;
an outlet of the main-side fluid flow path; and
an exhaust of the waste-side fluid flow path;
a thermoelectric device configured to convert electrical energy into thermal energy producing a temperature change in response to an electrical current being applied thereto, the thermoelectric device positioned between the main-side fluid flow path and the waste-side fluid flow path downstream of at least a portion of the central wall, the thermoelectric device having a main side aligned with the main-side fluid flow path and a waste side aligned with the waste-side fluid flow path;
a fluid moving device configured to produce a fluid flow along the fluid flow path that is in thermal communication with the thermoelectric device so that the thermal energy generated by the thermoelectric device is transferred to the fluid flow; and
a flow control valve positioned upstream of the thermoelectric device along the fluid flow path and positioned adjacent to the at least a portion of the central wall, the flow control valve configured to direct the fluid flow path into the main-side fluid flow path along the main side of the thermoelectric device and the waste-side fluid flow path along the waste side of the thermoelectric device, to at least partially close the waste-side fluid flow path and to at least partially close the main-side fluid flow path.

2. The system of claim 1, further comprising:
a control unit operatively connected with the fluid moving device and the flow control valve and configured to operate the fluid moving device and the flow control valve.

3. The system of claim 2, further comprising:
a sensor configured to provide a signal that is indicative of a temperature of the fluid flow,
wherein the control unit is configured to operate the flow control valve based on the signal.

4. The system of claim 2, wherein the control unit is configured to adjust the flow control valve wherein less than 20% of a total volume of the fluid flow on the main-side fluid flow path and the waste-side fluid flow path is directed to the main-side fluid flow path to achieve a high temperature differential between the main side and the waste side of the thermoelectric device.

5. The system of claim 2, wherein the control unit is configured to adjust a flow control valve position based on a desired main-side temperature.

6. The system of claim 5, wherein the control unit is configured to lower a main-side temperature and/or increase a temperature differential between the main side and the waste side by adjusting the flow control valve to direct more of the fluid flow to the waste-side fluid flow path than to the main-side fluid flow path.

7. The system of claim 1, wherein the fluid moving device is positioned upstream of the thermoelectric device and the flow control valve along the fluid flow path.

8. The system of claim 1, wherein the fluid flow over the main side of the thermoelectric device on the main-side fluid flow path is parallel to and in a same direction as the fluid flow over the waste side of the thermoelectric device on the waste-side fluid flow path.

9. The system of claim 1, wherein the flow control valve includes a louver coupled with a rotatable shaft of a motor.

10. The system of claim 1, wherein the central wall extends into the thermoelectric device between the main side and the waste side.

11. The system of claim 1, wherein the flow control valve comprises a flap valve.

12. A control method for a thermal conditioning system:
providing power to a TED of the thermal conditioning system having a main side and a waste side;
operating the thermal conditioning system in a first mode for a first period in which a fluid flow passes through the thermal conditioning system; and
directing the fluid flow with a valve during the first period such that a first portion of the fluid flow is directed through a waste-side flow path along the waste side of the TED at a first flow rate and a second portion of the fluid flow is directed through a main-side flow path along the main side of the TED at a second flow rate, wherein the valve is positioned adjacent a central wall positioned between the main-side flow path and the waste-side flow path, the central wall positioned at least partially upstream of the TED, wherein the valve is configured to at least partially close the waste-side flow path and to at least partially close the main-side flow path.

13. The control method of claim 12, further comprising:
detecting a target temperature of the fluid flow using a temperature sensor;
changing operation from the first mode to a second mode based on detecting the target temperature;
operating the thermal conditioning system in the second mode for a second period; and
adjusting a ratio between the first flow rate and the second flow rate as compared to the first mode.

14. The control method of claim 13, wherein the target temperature is detected on the main side.

15. The control method of claim 13, further comprising measuring a temperature differential between the waste-side flow path and the main-side flow path using temperature sensors and changing operation from the first mode to the second mode based on the measured temperature differential.

16. The control method of claim 13, further comprising detecting a target temperature differential between the waste-side flow path and the main-side flow path using temperature sensors, wherein the first period and the second period are set to maintain the target temperature differential.

17. The control method of claim 13, further comprising operating the thermal conditioning system in a third mode for a third period, wherein a rate of the fluid flow during the third period is less than the rate of the fluid flow during the second period.

18. The control method of claim 13, further comprising operating the thermal conditioning system in a third mode for a third period, wherein the power provided to the TED during the third period is decreased relative to the power provided to the TED during the second period.

19. The control method of claim 12, wherein the first mode is an initial mode.

20. A thermal conditioning system, comprising:
a TED having a main side and a waste side;
a housing comprising a fluid flow path, the fluid flow path including:
a main-side path along the main side of the TED;
a waste-side path along the waste side of the TED; and
an inlet conduit upstream of the main-side path and the waste-side path;
a fluid moving device configured to produce a fluid flow along the fluid flow path from the inlet conduit toward the main-side path and the waste-side path;
a first temperature sensor configured to measure temperature in the main-side path;
a second temperature sensor configured measure temperature in the waste-side path;
a valve positioned within the inlet conduit, the valve configured to at least partially block fluid communication between the inlet conduit and the main-side path based on a position of the valve to reduce fluid flow along the main-side path and increase fluid flow along the waste-side path and to at least partially block fluid communication between the inlet conduit and the waste-side path based on the position of the valve to reduce fluid flow along the waste-side path and increase fluid flow along the main-side path; and
a controller configured to:
operate the thermal conditioning system in a first mode for a first period in which the fluid moving device produces a first fluid flow that passes along the waste-side path at a first flow rate and a second fluid flow that passes along the main-side path at a second flow rate;
determine a temperature differential between the waste-side path and the main-side path based on temperature measurements received from the first temperature sensor and the second temperature sensor; and
operate the thermal conditioning system in a second mode for a second period based on the determined temperature differential, wherein in the second mode the position of the valve is adjusted relative to the position of the valve during the first mode to change a ratio between the first flow rate and the second flow rate.

21. The system of claim 20, wherein the first mode is an initial mode.

22. The system of claim 20, wherein the valve comprises a first louver configured to open, close and partially close fluid communication between the inlet conduit and the main-side path based on the position of the valve.

23. The system of claim 22, wherein the valve further comprises a second louver to control fluid communication between the inlet conduit and the waste-side path based on the position of the valve.

24. The system of claim 23, wherein the valve comprises a rotary valve with the first louver and the second louver.

25. The system of claim 20, wherein the housing further includes a bypass path configured to direct at least a portion of the fluid flow to bypass the main-side path and the waste-side path.

26. The system of claim 20, wherein the controller is further configured to adjust the position of the valve based on a desired main-side path temperature.
